(19) United States
(12) Patent Application Publication
(10) Pub. No.: US 2005/0227347 A1
(43) Pub. Date: Oct. 13, 2005

(54) Method of surface cleaning and treating waste product generated

(76) Inventors: David B. Gregory, Bay City, MI (US); William W. Soper, Bay City, MI (US)

Correspondence Address: REISING, ETHINGTON, BARNES, KISSELLE, P.C., P O BOX 4390, TROY, MI, 48099-4390, US

(21) Appl. No.: 11/096,439

(22) Filed: Apr. 1, 2005

Related U.S. Application Data
(60) Provisional application No. 60/561,684, filed on Apr. 13, 2004.

(51) Int. Cl. C12S 1/00

(52) U.S. Cl. 435/262.5

(57) ABSTRACT

A method of treating waste product containing biomass digestible product residues includes using a surfactant penetrant containing complex molecule enzymatic breakdown agent in the cleaning of waste products from processing surfaces to create a liquid waste stream including active enzymatic material. The method includes diluting the waste stream to a predetermined state and moving the liquid waste stream to a biomass having waste eating bacteria. The method further includes raising the metabolic rates of the bacteria in the biomass to increase their rate of digestion of the waste product in the waste stream while the enzymatic material remains active to simplify complex molecules in the waste.

### REFERENCE TO CO-PENDING APPLICATION

This application claims the benefit of U.S. Provisional Application Ser. No. 60/561,684, filed Apr. 13, 2004.

### BACKGROUND OF THE INVENTION

1. Field of the Invention

This invention relates generally to methods for cleaning waste products from surfaces, and more particularly to methods of cleaning including the use of a biomass to digest waste products.

2. Related Art

The removal and treating of waste products, such as, for example, silicone emulsions containing fats, oils and greases in industrial applications, can be difficult. Such products are not generally amenable to a treating process which generally includes the removal or breaking down of both natural and synthetic organic contaminants by passing the waste products through an oxygenizing biomass which generally contains both single and multi-cellular bacterial organisms.

Maintaining a live biomass is critical to a waste treatment process. The presence of toxins or sudden environmental changes can result in degradation and/or killing of the biomass, thereby allowing waste products to pass through the biomass system without being purified or broken down. The resulting environmental damage from a degraded or failed biomass can require considerable expense, time and effort to restore. Generally, the biomass must also be restored, either through natural restoration or through an artificial treatment. In either case, the restoration of the biomass requires tight controls and significant monitoring, which can ultimately be very costly. In the meantime, prior to the full restoration of the biomass, additional toxins within the waste products may further complicate the restoration process and may further damage the surrounding environment. Accordingly, to avoid harmful effects from an environment exposed to the flow of partially or fully untreated waste water, great care must be taken throughout the treating of the waste water to avoid incapacitating the biomass through which the waste waters flow.

### SUMMARY OF THE INVENTION

A method of treating waste product containing biomass digestible product residues includes using a pH neutral complex molecule enzymatic breakdown agent in the cleaning of waste products from processing equipment and other exposed surfaces in the first place which generates a liquid waste stream including active enzymatic material. In addition, the method includes moving the liquid waste stream to a biomass having active or activatable waste eating bacteria. The method further includes raising the metabolic rates of the bacteria in the biomass to increase their rate of digestion of the waste product in the waste stream while the enzymatic material remains active to continue its breakdown function.

The method provides a mechanism of treating waste product for disposal to the environment that resists harmful effects to the environment. Ideally, the waste product can be introduced into a biomass in a state wherein the biomass can generally immediately begin digesting the waste product to eliminate any harmful effects to the environment. When the disposal system cannot practically supply the required dilution it has been discovered that the biomass can be conditioned to acclimate over a predetermined short period of time prior to its digesting the waste product. The enzymatic material is presented to the biomass in a concentration that resists killing the biomass, and therefore, allows the waste product to eventually be digested by the biomass.

Some of the objects, features and advantages of this invention include providing a method for treating waste product such that the waste product is digestible by a natural or organic biomass, reduces the amount of time required for a biomass to digest or oxygenate the waste product, reduces the harmful effects of the waste product on the environment, and reduces the cost associated in treating waste product using an enzymatic material that remains active for a relatively long period in storage and remains active while in use.

### BRIEF DESCRIPTION OF THE DRAWINGS

These and other objects, features and advantages of this invention will become readily apparent to one having ordinary skill in the art in view of the following detailed description and best mode, appended claims and drawings, in which:

FIG. 1 is a schematic block diagram illustrating the process of the invention;

FIG. 2 is a schematic block diagram showing the steps for treating the enzymatic solution according to one aspect of the invention; and

FIG. 3 is a graph illustrating acclimatization and increases in biomass metabolic rates.

### DETAILED DESCRIPTION OF THE PREFERRED EMBODIMENTS

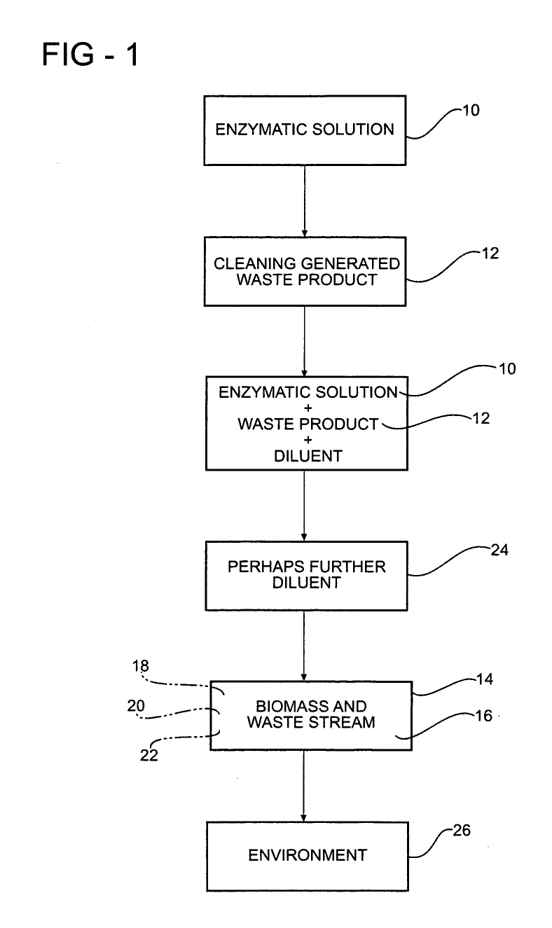

Referring in more detail to the drawings, FIG. 1 shows one aspect of the invention for introducing an enzymatic cleaning solution 10 to a residual waste product 12, such as may be found adhered to the surface of a closed cosmetic mixing vat or vessel, for example, wherein the enzymatic solution 10 facilitates cleaning the waste product 12 from the vessel. Upon cleaning the waste product 12 from the surfaces of the vessel, the residual mixture of enzymatic solution 10 and waste product 12 formed are introduced into a waste stream 14 flowing to a waste eating biomass 16 having many different organisms or bacteria housed in a container, such as a pretreatment septic tank system 18, or an equalization chamber 20, or may be introduced directly into a sewer system 22 leading to the biomass chamber. The enzymatic activity removes contaminants from the vessel surfaces by breaking apart the adhered complex molecular structures into simpler forms. The simple forms are more readily consumed by the biomass and the enzymatic activity continues to simplify other waste present. To reduce the potential for harm to the biomass 16, the enzymatic solution 10 is treated by introducing a diluent 24, such as water, for example, to the extent necessary to ensure that the biomass 16 becomes or remains active to feed on the waste product 12. The many unicellular or multicellular organisms or bacteria within the biomass insure the proper treatment of the waste product 12 within the waste stream 14 prior to the waste stream being introduced into a surrounding environment 26. As such, when the waste stream 14 is finally expelled to its respective environment 26, the potential for harmful side effects to the environment 26 is minimized.

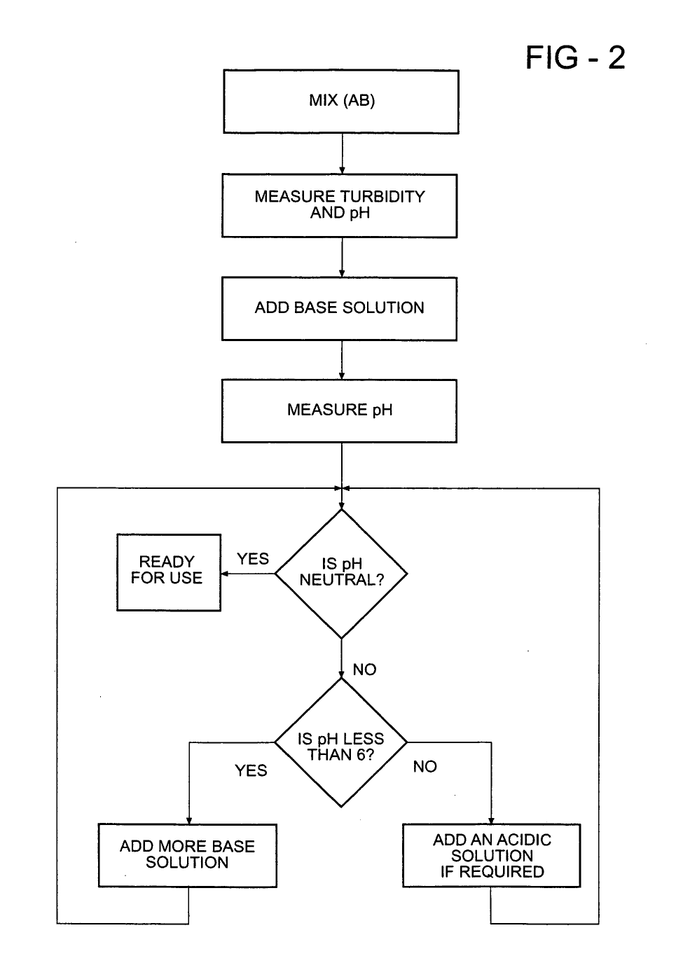

As shown in FIG. 2, the environmentally non-toxic enzymatic solution 10 is generally produced as a base solvent mixture having no anti-bacterial activity and including a surfactant-penetrant-releasing agent (A) and an enzyme component solution such as can be purchased from Renew Systems, Inc., of Bay City, Mich., under the product designation Silzyme™, referred to hereafter as (B). The liquid mixture (A) may include N-Methyl-2-Pyrrolidone as a surfactant-solvent (2.3-2.4%), ethoxylated octyl phenol as a binder-thickener (2.2-2.3%) and texanol (1.5-1.6%) as a penetrant with the balance typically water. The surfactant-penetrant system (A) acts at least in part to inhibit harm to the biomass 16 by preventing the biomass 16 from being smothered by oil, grease and fat waste. The enzymatic solution (B) may contain one or more enzymes such as lipase, alpha-amylase, protease (1.8-1.9%), or the like, or a mix thereof in an enzyme protectant stabilizer solution including propylene glycol (1.8-1.9%), or the like. The mixture of (A) and (B) is generally in the volume/ratio of at least 90 parts (A) to 10 parts (B) or alternatively 10 parts (A) to 1 part (B), with the percentages indicated specified by volume. The resulting mixture is blended for about two hours, and thereafter, turbidity and pH measurements are taken. Alternatively, enzymatic cleansers which can be purchased as Renew Systems Acqueous Reactivator™, Xzyme™, and Decontaminator™ are expected to be useful as cleaning solutions. The term enzyme is intended herein to include the well known complex proteins produced by the living cells of high molecular weights and consisting of multiple amino acids combined in a characteristic sterically oriented structure and newer and genetically engineered enzyme compositions. A variety of basic enzyme types may include hyrdolases, isomerases, ligases, lyases, oxidoreductases, and transferases. More specifically, the enzyme may come from the fermentation of a strain of Baccilus licheniformis. The percentage of enzymes by volume used in part (B) may be in the range 0.5-3% by volume.

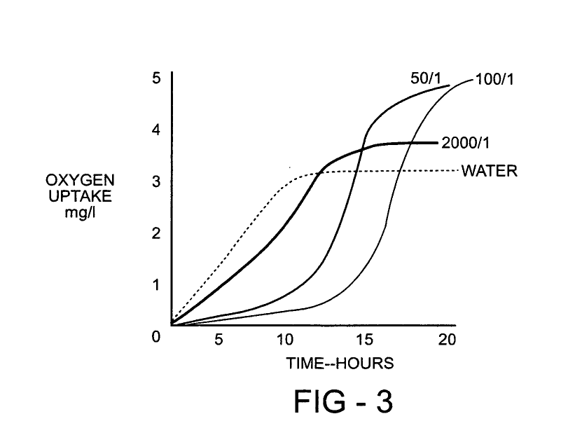

Upon measuring the pH of the mixture (AB), it is determined how much of a base solution, such as sodium borate (NaBO₄) mixed in water, designated hereafter as (C), needs to be added to the mixture (AB) to bring the mixture up to a workable pH neutral range, defined as being between 6-8 on the pH scale. Upon adding the determined amount of the base solution (C) to the mixture (AB), the pH is measured again (see FIG. 3). If the pH is within the designated pH neutral range, then the resulting mixture (AB) and (C), hereafter referred to as (ABC), is ready for use. However, if the mixture (ABC) is not within the pH neutral range, more base solution (C) may be added to raise the pH level, or an acidic solution, such as citric acid or hydrochloric acid solution, for example, can be added to the mixture (ABC) to reduce the pH. Generally, the mixture (ABC) can be used immediately, or stored at ambient temperatures generally between 52-78 degrees, for up to 90 days or more.

In use, prior to, or immediately following, introducing the liquid mixture (ABC) to the biomass 16, it is important to precondition the mixture (ABC) to a predesignated ratio of mixture (ABC) to diluent 24. Desirably, the mixture (ABC) includes water in a ratio of 1 part mixture (ABC) to 2000 parts water, if this supply of water is available in the sewer system. As illustrated graphically in FIG. 3, at this ratio, respirometer validation test results have shown that the time lag for the biomass 16 to acclimate to the newly introduced waste stream 14, at which point the biomass 16 begins digesting the waste products 12, is negligible. Test results also have shown that the waste oxygenation results are at least as favorable and generally somewhat more favorable than produced with testing control water alone. Importantly, the mixture (AB) or (ABC) with waste products 12 may be introduced to the biomass 16 in a less dilute state, including down to 1 part mixture (ABC) and waste product to 50 parts water. At this ratio, respirometer test results have shown that the biomass 16 remains generally inactive or unacclimated for the first 12 hours, and then, unexpectedly, begins to digest the waste products 12 at ultimately an increased rate, ultimately resulting in respirometer readings up to, and exceeding that of water alone (FIG. 3). Accordingly, it is necessary to dilute the mixture (ABC) to at least a predetermined extent prior to introducing the mixture (ABC) along with the waste products 12 into the biomass 16. It should be recognized that many sources of waste water flowing within an industrial facility may combined in a common line or drain system to contribute to the dilution of the mixture (ABC) prior to its reaching the primary biomass 16. It should also be recognized that at least a portion of the diluent 24 may be introduced to the waste stream 14 through the receptacle being cleaned. Desirably, the diluent 24 may be added to the receptacle and released to the waste stream line 14 during, or immediately after, removing or draining the mixture (ABC) from the receptacle. The water is metered in as necessary according to the dilution state of the waste stream reaching the biomass as measured by respirometer test results or another suitable measuring system. An ideal waste stream would include diluent such as water in the range of 2,000 to 100,000 parts to one part of mixture (ABC). Where the ratio of Silzyme™ to synthetic shampoo wastewater is 1/1000, the biochemical oxygen demand (BOD) is approximately 58% of the chemical oxygen demand (COD). For the synthetic wastewater only, the BOD represents approximately 51% of the COD. The Silzyme™ treated waste water with its higher percent of BOD represents a more treatable waste for a biological system.

Upon reaching the desired ratio of mixture (ABC) to diluent 24, the mixture (ABC) carrying waste product 12 with product residues, such as silicone, fats, and greases, or it is believed, synthetic plastics, latex and oils, for example, reaches the biomass 16. Such waste products 12 may be found, by example and without limitation, in a vessel used to formulate cosmetics. Upon treating the vessel, the resulting mixture (ABC) and diluent 24 along with the waste products 12 are ultimately transferred to the environment 26 via the waste stream 14, such as through direct discharge into a drain leading to a biomass sewer system, for example. Throughout the cleaning and digestion process the temperature of the solution AB or ABC remains at an activation temperature in which the enzymatic solution catalyzes or accelerates the breakdown of the larger more complex waste molecules into simpler, easier to digest forms which lead to increased metabolic rates in the biomass 16. It should be recognized that the sewer system may contain a naturally occurring biomass 16 having active waste eating bacteria resulting from everyday waste, including fecal matter and the like, for example, housed in a septic tank. It should also be recognized that rather than a direct discharge into the sewer system, the mixture (ABC) and waste products 12 may preferably be introduced to a pretreatment system 18, such as a filtration device to assist in removing solids, while generally allowing fluids to flow therethrough, for example. Various well known filtration devices are contemplated herein, such as filtration membranes, sand filters, belt presses, plate and frame filters and centrifuge devices, for example.

Otherwise, the mixture (ABC) and diluent 24 along with the waste product 12, such as siloxane oil, for example, may be introduced to an equalization (accumulation) system 20 having a naturally occurring or artificially provided biomass 16 therein. The artificially provided biomass 16 can be purchased from many companies, such as from BioChem® Technology, Inc. in King of Prussia, Pa., or Biodyne of Sarasota, Fla., for example. The biomass 16 then will be conditioned to acclimate to the waste stream characteristics and environmental conditions within the particular industrial facility. The equalization tank 20 provides time for the biomass 16 to acclimate to the presence of the mixture (ABC) and waste products 12, thus, providing the time necessary for the metabolic rates of the bacteria within biomass 16 to increase their rates of ingestion and digestion of the waste product 12 while the enzymatic solution within the mixture (ABC) remains active to enzymatically break down the complex molecules in the waste. Temperatures are maintained generally in the range 37 degrees centigrade to 45 degrees centigrade for most desirable results. As such, the biomass 16 is able to act on the waste product 12 prior to its being introduced to the environment 26. Desirably, a dissolved oxygen sensor can be used in combination with a display panel to graphically depict an instantaneous readout of the oxygen levels within the biomass effluent. A suitable DO meter (respirometer) may be purchased from A. Daigger and Company, Inc., of Vernon Hills, Ill., as the YSI 550A, DO meter with probe, to measure dissolved oxygen at the biomass 16. Accordingly, it can readily be determined when the oxygen within the biomass 16 is being measured at a rate indicative of the biomass 16 being fully acclimated or operative. Upon the biomass 16 being acclimated, and thus, having begun to digest the waste products 12, further introduction of waste products 12 into the biomass 16 results in the continued digestion by the biomass 16 of the waste products 12. As such, once the ingestion process has begun, it remains continuous, unless of course, the presence of waste product 12 or otherwise biomass digestible residues are completely depleted from the already activated biomass 16 for a lengthy time. In order for the biomass to undesirably become deacclimated, generally a period corresponding to 2-3 times the average cell retention time in the biomass 16 is required.

Examples of the use of the process described are believed to be as follows:

### EXAMPLE

A pH neutral silicone (siloxane) emulsion with intermixed oils, fats and greases is scrubbed from the walls of a reaction and mixing container by introducing a pH controlled liquid spray of Silzyme™ (ABC). After about a two hour cleaning cycle, the residue stream is drained from the now cleaned vessel surfaces and sewered to a releasably closed equalization or other tank such as a septic tank containing a biomass body of living bacteria. The ABC spray is normally introduced to the vessel to be cleaned or treated in a dilute state, but may not be. If not, water is used to flush the vessel in at least a ratio of one part ABC to 50 parts water by volume. In any event, the water content introduced with the ABC solution and the water introduced in flushing is metered to achieve at least the 50-1 ratio at the biomass. Respirometer testing will indicate the biomass remained inactive for about 12 hours, after which it acclimates and begins to process (break down) the fluid residue mixture and continues to do so long as it continues to be supplied with other residual mixtures from other cleaning vessels as the cleaning crews moved from vessel to vessel. At this point the septic or other tank could release the residual stream to the environment. The biomass remains active and acclimated so long as the supply of material is not interrupted for a lengthy time, i.e., 24-36 hours. The ph content at the biomass is continually monitored and adjusting solution added when necessary to maintain the ph neutral condition.

### FURTHER EXAMPLES

At a dilution of 1 part ABC to 20 parts water the biomass failed (was killed). At dilutions of 1 to 50, 1 to 100, and 1 to 200 acclimization occurrs within a 12 hour period. At 1 to 2,000, basically no acclimization time is required and the metabolic rate of waste consumption (oxygenization) as measured by the respirometer is somewhat greater than that achieved with water alone. The preferred dilution is a dilution of 1 to 100.

It should be recognized that the embodiments discussed above are exemplary embodiments, and thus are intended to be illustrative and not limiting. The scope of the invention is defined by the claims that follow.

1. A method of treating waste product containing biomass digestible product residues such as silicone, fats, greases, synthetic plastics and oils having complex molecules in their molecular structure comprising:
a. using a dilutable complex molecule enzymatic breakdown agent in the cleaning of said residues from processing surfaces which results in the generation of a substantially liquid waste stream comprising decomplexed residue molecules and including said enzymatic breakdown agent;
b. moving said stream to a biomass having waste eating bacteria;
c. prior to step b., diluting said waste stream to a predesignated ratio of waste stream to diluent to precondition it for said biomass while keeping a volume of said enzymatic material in an active state capable of further residue breakdown activity;
d. raising the metabolic rates of the bacteria and increasing their rate of digestion, upon said waste stream having a predetermined diluent state and while said enzymatic material continues its complex molecule breakdown activity; and thereby
e. creating an environmentally acceptable effluent and to discharge the effluent from said biomass to the environment.

2. The method of claim 1 wherein said diluent is water in a ratio substantially at least 50 parts water to one part agent.

3. The method of claim 1 wherein, once said metabolic rates have been raised and maintained, the rate of digestion is substantially continuous.

4. The method of claim 3 wherein an initial period of at least twelve hours is used in acclimatizing the biomass for biomass consumption.

5. The method of claim 1 wherein the ratio of agent to diluent includes mixing 1 part agent with 2,000 parts diluent.

6. The method of claim 1 including the step of mixing said enzymatic material with a surfactant penetrant solution to produce said complex molecule enzymatic breakdown agent.

7. The method of claim 6 including mixing at least ten parts of the surfactant penetrant solution to one part of a stabilized enzymatic cleaner solution.

8. The method of claim 1 including adding a pH control solution to the prediluted complex molecule enzymatic breakdown agent to produce said dilute complex molecule enzymatic breakdown agent to a pH neutral state.

9. The method of claim 8 including using a sodium borate solution as the control solution.

10. The method of claim 8 including using an acidic solution as the control solution.

11. The method of claim 1 including monitoring said biomass to determine an oxygen level within the biomass and discharging the effluent from said biomass to the environment upon the oxygen level reaching a predetermined level.

12. A method of treating waste product containing biomass digestible product residues such as silicone oil, comprising:
a. using a dilutable complex molecule enzymatic breakdown agent in the cleaning of silicone emulsion processing vessels which results in the generation of a basically liquid waste stream including active enzymatic material, said agent comprising N-methyl-2 pyrrolidone as a surfactant and toxanol as a penetrant together with an enzyme generated in the licheniformis;
b. moving said stream to a biomass having waste eating bacteria;
c. prior to step b., diluting said waste stream with a diluent comprising water to a predesignated ratio of waste stream to diluent to precondition it for said biomass while keeping said enzymatic material in an active state;
d. subjecting said biomass to said waste stream for a period of time sufficient to acclimatize it to an active state;
e. raising the metabolic rates of the bacteria and increasing their rate of digestion, upon said waste stream having a predetermined diluent state and while said enzymatic material remains active and continues its complex molecule breakdown activity and preventing smothering of said biomass so that it cannot function; and
f. measuring said rate of digestion and upon its reaching a predetermined rate discharging the effluent from said biomass to the environment.

13. The method of claim 12 wherein said diluent is water in a ratio substantially at least 50-100 parts water to one part agent.

14. The method of claim 13 wherein an initial period of at least twelve hours is used in acclimatizing the biomass for biomass consumption.

15. The method of claim 14 wherein the ratio of agent to diluent includes mixing 1 part agent with 2,000 parts diluent.

16. The method of claim 13 including the step of mixing said enzymatic material with a surfactant penetrant solution comprising providing said solution by volume as 2.3-2.4% surfactant to 1.5-1.6% toxanol in a binder-water mix.

17. The method of claim 16 including mixing at least ten parts of said solution to one part of a stabilized aqueous enzymatic material solution.

18. The method of claim 13 including adding a pH control solution to the prediluted complex molecule enzymatic breakdown agent to produce said dilute complex molecule enzymatic breakdown agent to a pH neutral state and maintaining said state at the biomass.

19. The method of claim 13 including monitoring said biomass to determine an oxygen level within the biomass and discharging the effluent from said biomass to the environment upon the oxygen level reaching a predetermined level.

20. The method of claim 1 wherein the agent comprises protease in a water solution with surfactant penetrants.

21. The method of claim 12 including introducing at least part of said diluent through the receptacle being cleaned after said breakdown agent has been removed from the receptacle.
